(19) United States
(12) Patent Application Publication
(10) Pub. No.: US 2019/0109906 A1
(43) Pub. Date: Apr. 11, 2019

(54) CONTROL APPARATUS FOR RECOGNIZING A FAR END

(71) Applicant: AnJet Technology Co., Ltd., Honk Kong (CN)

(72) Inventors: Chien Liang KUO, Hong Kong (CN); Hai Fang LIU, Hong Kong (CN)

(21) Appl. No.: 15/725,985

(22) Filed: Oct. 5, 2017

(51) Int. Cl. H04L 29/08; H04W 76/02; H04W 4/00; G06K 7/14

(52) U.S. Cl. CPC H04L 67/125; H04W 76/021; H04W 4/006; H04W 4/003; G06K 7/1417; H04W 4/008; H04W 76/026

(57) ABSTRACT

A control apparatus for recognizing a far end includes a controllable device, at least one hand-held electronic device, and a cloud serving control device. The controllable device corresponds to a user identifier. The hand-held electronic device retrieves the user identifier. The cloud serving control device is wirelessly connected with the hand-held electronic device and the controllable device and receives the user identifier transmitted from the hand-held electronic device to recognize the user identifier and the identification of the hand-held electronic device and selectively transmit a control command to the controllable device. The controllable device is wirelessly connected with and controlled by the hand-held electronic device recognized according to the control command.

### BACKGROUND OF THE INVENTION

### Field of the Invention

The present invention relates to a control apparatus, particularly to a control apparatus for recognizing a far end through a third party.

### Description of the Related Art

Nowadays, with the improvement of technology, everyone has a mobile phone everywhere. Everyone uses a smart phone or a portable tablet computer. Users use it to communicate with each other, recreate, or search data. Most of users use a smart phone or a tablet computer to link to a wireless network. Even if the user device does not directly link to a wireless network, the user device connects to a WiFi access point for free in many environments. Thus, the current technology is very convenient.

In general, a smart phone or a tablet computer is used to communicate with a specific device in many environments. For example, the smart phone scans a QR code or a two dimensional code of the specific device to retrieve data stored thereof. Alternatively, the specific device is controlled by the smart phone in a simple way. In general, a device that can be used at any time has low-level access, such as a smart phone or a tablet computer. Thus, using the device that has low-level access does not take too many risks.

As a result, the smart phone cannot perform further communication. Alternatively, businessmen, who provide devices for users for free, do not know from these devices the habit of the users or functions used by the users. Thus, the smart phone cannot control and communicate with a controllable device effectively.

To overcome the abovementioned problems, the present invention provides a control apparatus for recognizing a far end. The control apparatus uses a smart phone or a tablet computer to control and communicate with a device to be used through a third-party device.

### SUMMARY OF THE INVENTION

A primary objective of the present invention is to provide a control apparatus for recognizing a far end, which uses a hand-held electronic device, such as a smart phone or a tablet computer. The hand-held electronic device wirelessly connects with a third-party device. Thus, a user directly uses the hand-held electronic device to obtain the access to control a controllable device to be used through a third-party controller.

Another objective of the present invention is to provide a control apparatus for recognizing a far end, which uses a hand-held electronic device of a user to match controllable devices in an environment and obtain the access to control the controllable device. Then, the control apparatus keeps records of using the hand-held electronic device in a cloud device, so as to maintain the controllable device. Alternatively, businessmen of the controllable device may charge by the records.

To achieve the abovementioned objectives, the present invention provides a control apparatus for recognizing a far end. The control apparatus comprises a controllable device, at least one hand-held electronic device, and a cloud serving control device. The controllable device corresponds to a user identifier. The hand-held electronic device retrieves the user identifier. The cloud serving control device is wirelessly connected with the hand-held electronic device and the controllable device and receives the user identifier transmitted from the hand-held electronic device to recognize the user identifier and the identification of the hand-held electronic device and selectively transmit a control command to the controllable device. The controllable device is wirelessly connected with and controlled by the hand-held electronic device recognized according to the control command.

In an embodiment of the present invention, the cloud serving control device further comprises a cloud server and a wireless controller. The cloud server is wirelessly connected with the hand-held electronic device to receive and recognize the user identifier. The wireless controller is wirelessly connected with the cloud server and the controllable device. When the user identifier recognized by the cloud server is correct, the wireless controller transmits the control command to the controllable device.

In an embodiment of the present invention, when the hand-held electronic device is disconnected from the controllable device, the hand-held electronic device transmits its recording data to the cloud serving control device.

In an embodiment of the present invention, the recording data are time that the hand-held electronic device controls the controllable device, records of using the hand-held electronic device, or data of using the controllable device.

In an embodiment of the present invention, when the controllable device is disconnected with the hand-held electronic device, the controllable device is powered off and the controllable device transmits powered-off information to the cloud serving control device.

In an embodiment of the present invention, the hand-held electronic device is a smart phone or a tablet computer.

In an embodiment of the present invention, the controllable device is an industrial machine, a household electronic device, or a public electronic device.

In an embodiment of the present invention, the controllable device, the hand-held electronic device, and the cloud serving control device are wirelessly connected with each other through WiFi communication, bluetooth communication, the Internet of things (IoT), or a mobile communication system.

In an embodiment of the present invention, the hand-held electronic device executes a built-in mobile application (App) program to wirelessly connect with and control the controllable device and uses the mobile app to communicate with the cloud serving control device.

In an embodiment of the present invention, the user identifier is a QR code, a two dimensional code, a pattern, or a near field communication (NFC) tag.

Below, the embodiments are described in detail in cooperation with the drawings to make easily understood the technical contents, characteristics and accomplishments of the present invention.

### BRIEF DESCRIPTION OF THE DRAWINGS

FIG. 1 is a diagram showing a control apparatus for recognizing a far end according to the first embodiment of the present invention;

FIG. 2 is a diagram showing a control apparatus for recognizing a far end according to the second embodiment of the present invention; and

FIG. 3 is a diagram showing a controllable device disconnected from a hand-held electronic device according to an embodiment of the present invention.

### DETAILED DESCRIPTION OF THE INVENTION

Smart phones were invented to replace the conventional electronic devices. With the popularity of a wireless network, users more easily use smart phones to communicate with each other. After recognizing and verifying the identification of a smart phone, a user adopts the smart phone to control many devices and store records of using the smart phone.

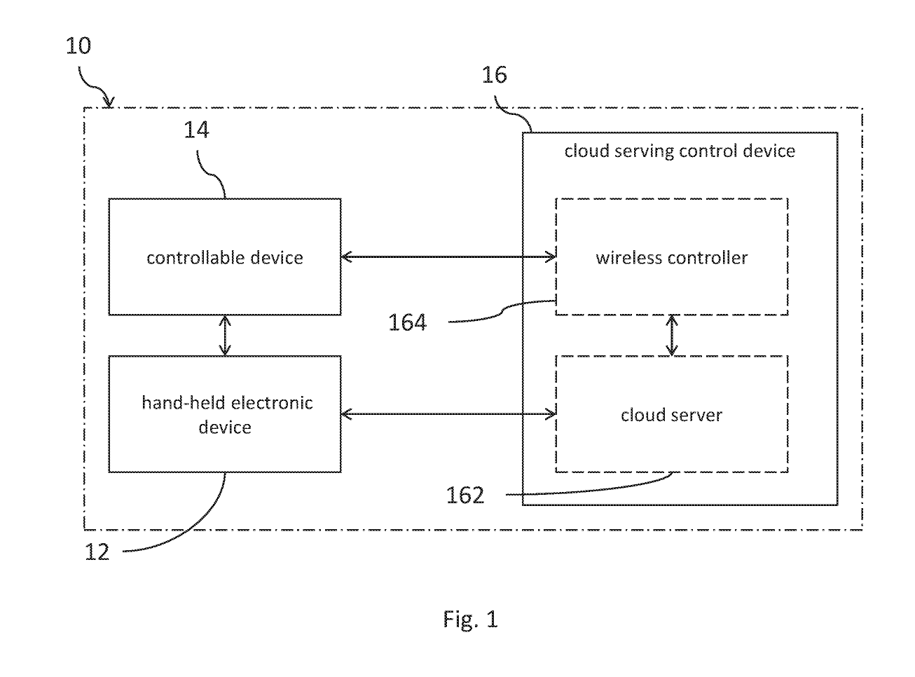

Refer to FIG. 1. A control apparatus 10 for recognizing a far end comprises at least one hand-held electronic device 12, a controllable device 14, and a cloud serving control device 16. The cloud serving control device 16 is wirelessly connected with the hand-held electronic device 12 and the controllable device 14. The controllable device 14 corresponds to a user identifier. The embodiment exemplifies one hand-held electronic device 12. The hand-held electronic device 12 is a smart phone. The controllable device 14 is an industrial machine, a household electronic device, or a public electronic device. The type of the controllable device 14 depends on an environment that a user is located. The present invention should not be limited to the type and operation of the controllable device 14. The user identifier is a QR code, a two dimensional code, a geometric pattern, a texture, or a near field communication (NFC) tag. For example, a user uses the hand-held electronic device 12 to scan the QR code to wirelessly connect with the controllable device 14. The present invention should not be limited to the number of the hand-held electronic device 12. The hand-held electronic device 12 may be a tablet computer.

Continuing from the abovementioned paragraph, the cloud serving control device 16 includes a cloud server 162 and a wireless controller 164 wirelessly connected with the wireless controller 164 and the controllable device 14. The cloud server 162 is wirelessly connected with the hand-held electronic device 12. The controllable device 14, the hand-held electronic device 12, and the cloud server 162 and the wireless controller 164 of the cloud serving control device are wirelessly connected with each other through WiFi communication, bluetooth communication, the Internet of things (IoT), a mobile communication system, a 3G system, 4 G system, a 5G system, LoRa wireless technology, or NB-IoT wireless technology.

After explaining the architecture of the present invention, the operation of the present invention is described as follows. Refer to FIG. 1. The user uses the hand-held electronic device 12 to scan and retrieve the user identifier of the controllable device 14. Afterwards, the hand-held electronic device 12 executes a built-in mobile application (App) program to transmit register data corresponded thereof and the user identifier to the cloud serving control device 16. The cloud server 162 recognizes the user identifier. Besides, the cloud server 162 compares preset data with the register data to verify the identification of the hand-held electronic device 12. For example, the cloud server 162 determines whether the hand-held electronic device 12 has the access to control the controllable device 14 and whether the register data of the hand-held electronic device 12 is stored in the cloud server 162 in advance. When the cloud server 162 determines that the hand-held electronic device 12 has the access to control the controllable device 14 and that the register data of the hand-held electronic device 12 is stored in the cloud server 162 in advance, the wireless controller 164 transmits a control command to the controllable device 14. Thus, the cloud serving control device 16 selectively transmits the control command to the controllable device 14. When the hand-held electronic device 12 does not have the access to control or apply the controllable device 14, the cloud serving control device 16 does not transmit the control command to the controllable device 14. When the cloud server 162 determines that the hand-held electronic device 12 has the access to control or apply the controllable device 14, the hand-held electronic device 12 executes the mobile application program to display a word message or an image that represents successful recognition. Thus, the user knows that the hand-held electronic device 12 has the access to control or apply the controllable device 14. As a result, the controllable device 14 is wirelessly connected with and controlled by the hand-held electronic device 12 recognized according to the control command.

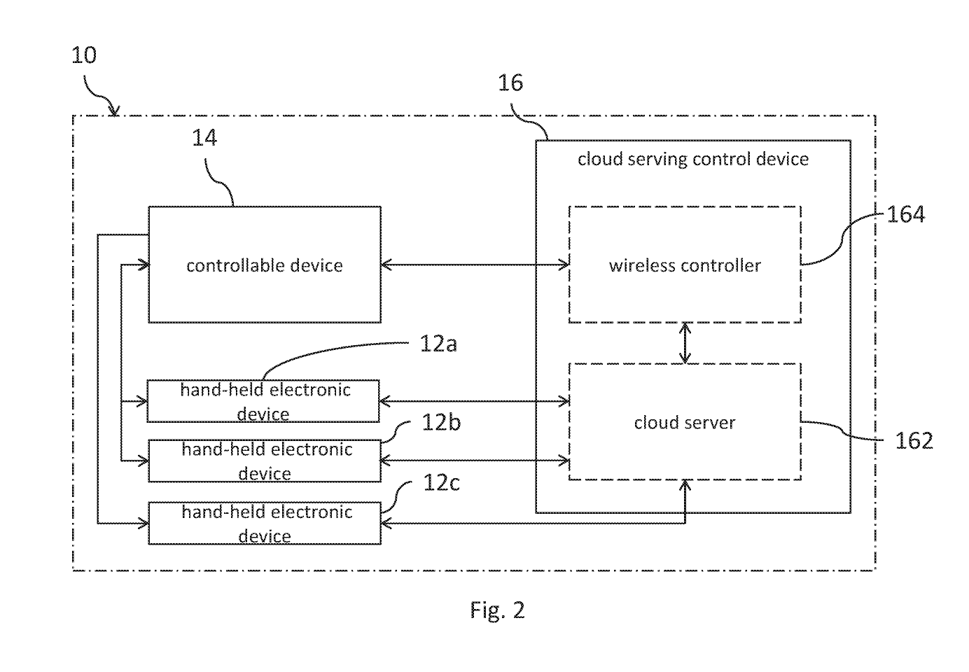

Refer to FIG. 2. The abovementioned embodiment exemplifies one hand-held electronic device. After successfully recognizing the hand-held electronic device, multiple users use their hand-held electronic devices to connect with the controllable device. For instance, three users use their hand-held electronic devices 12a, 12b, and 12c to control the controllable device 14. After the hand-held electronic devices 12a, 12b, and 12c retrieve the user identifier, the cloud serving control device 16 recognizes the user identifier and the identification of the hand-held electronic devices 12a, 12b, and 12c. The identification process of the hand-held electronic devices 12a, 12b, and 12c is the same to that of the abovementioned embodiment so will not be reiterated. After the identification process, one of the hand-held electronic devices 12a, 12b, and 12c may not have the access to control or apply the controllable device 14. For example, the hand-held electronic device 12c does not be accepted by the cloud serving control device 16. Thus, the hand-held electronic device 12c does not have the access to control the controllable device 14. The identification process has an advantage. When the controllable device 14 is unique or exclusive, the cloud serving control device 16 filters the hand-held electronic devices. Not everyone uses his/her hand-held electronic device to control the controllable device 14.

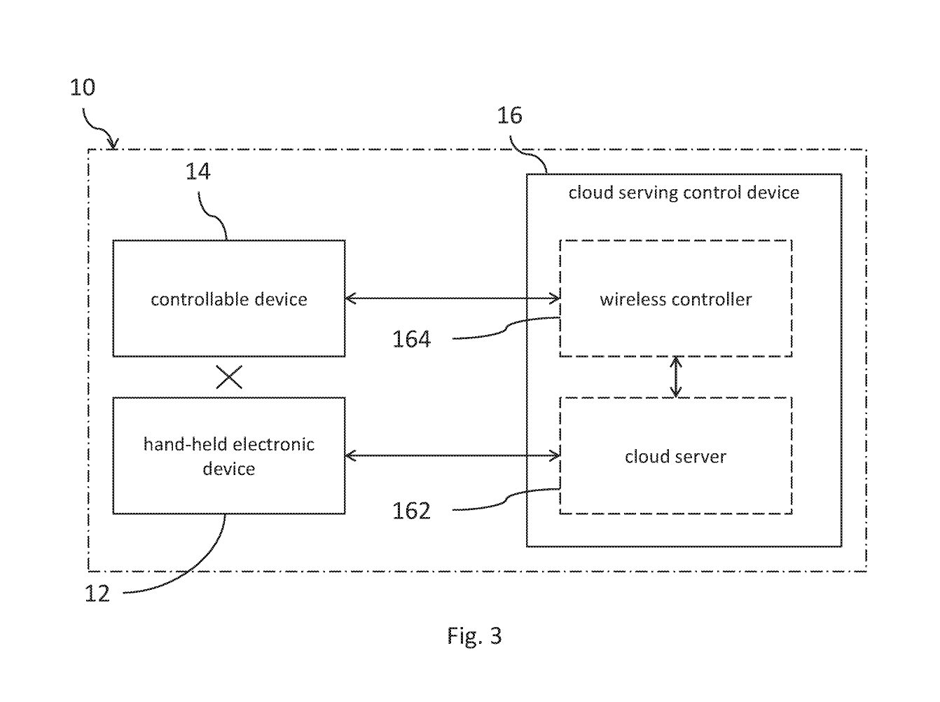

Refer to FIG. 3. Continuing from the abovementioned paragraph, the hand-held electronic device 12 is disconnected from the controllable device 14 when the user does not intend to control the controllable device 14. When all the hand-held electronic devices 12 are disconnected from the controllable device 14, the controllable device 14 is powered off and the controllable device 14 transmits powered-off information to the cloud serving control device 16. Each hand-held electronic device 12 transmits its recording data to the cloud serving control device 16 when the hand-held electronic devices 12 are disconnected from the controllable device 14. The recording data are time that at least one hand-held electronic device 12 controls the controllable device 14, records of using at least one hand-held electronic device 12, or data of using the controllable device 14. At last, the cloud serving control device 16 organizes and compares all the data. In this way, businessmen organize the recording data. Alternatively, the businessmen charge by the recording data. For example, the businessmen charge by time that the user uses the controllable device 14.

Accordingly, the cloud serving control device of the present invention not only performs a recognition process but also stores data, such as time that the hand-held electronic device is connected with the controllable device or records that the user controls the controllable device. The cloud serving control device organizes the data to conveniently modify the controllable device later on.

The present invention should not be limited to the number of the hand-held electronic devices, such as smart phones or tablet computers, which are connected with the controllable device. The user can decide the number of the hand-held electronic devices connected with the controllable device. As long as the controllable device has multiplex properties, the controllable device is controlled by many hand-held electronic devices. Since the cloud serving control device filters the hand-held electronic devices, the controllable device is not controlled by the hand-held electronic device that lacks the access, such that the controllable device is completely protected.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A control apparatus for recognizing a far end comprising:
a controllable device corresponding to a user identifier;
at least one hand-held electronic device retrieving the user identifier; and
a cloud serving control device wirelessly connected with the at least one hand-held electronic device and the controllable device and receiving the user identifier transmitted from the at least one hand-held electronic device to recognize the user identifier and identification of the at least one hand-held electronic device and selectively transmit a control command to the controllable device, the controllable device is wirelessly connected with and controlled by the at least one hand-held electronic device recognized according to the control command.

2. The control apparatus for recognizing the far end according to claim 1, wherein the cloud serving control device further comprises:
a cloud server wirelessly connected with the at least one hand-held electronic device to receive and recognize the user identifier; and
a wireless controller wirelessly connected with the cloud server and the controllable device, and when the user identifier recognized by the cloud server is correct, the wireless controller transmits the control command to the controllable device.

3. The control apparatus for recognizing the far end according to claim 1, wherein when the at least one hand-held electronic device is disconnected from the controllable device, the at least one hand-held electronic device transmits its recording data to the cloud serving control device.

4. The control apparatus for recognizing the far end according to claim 3, wherein the recording data are time that the at least one hand-held electronic device controls the controllable device, records of using the at least one hand-held electronic device, or data of using the controllable device.

5. The control apparatus for recognizing the far end according to claim 3, wherein when the controllable device is disconnected with the at least one hand-held electronic device, the controllable device is powered off and the controllable device transmits powered-off information to the cloud serving control device.

6. The control apparatus for recognizing the far end according to claim 1, wherein the at least one hand-held electronic device is a smart phone or a tablet computer.

7. The control apparatus for recognizing the far end according to claim 1, wherein the controllable device is an industrial machine, a household electronic device, or a public electronic device.

8. The control apparatus for recognizing the far end according to claim 1, wherein the controllable device, the at least one hand-held electronic device, and the cloud serving control device are wirelessly connected with each other through a WiFi communication, a bluetooth communication, an Internet of things (IoT), or a mobile communication system.

9. The control apparatus for recognizing the far end according to claim 1, wherein the at least one hand-held electronic device executes a built-in mobile application (App) program to wirelessly connect with and control the controllable device and uses the mobile app to communicate with the cloud serving control device.

10. The control apparatus for recognizing the far end according to claim 1, wherein the user identifier is a QR code, a two dimensional code, a pattern, or a near field communication (NFC) tag.
